(19) United States
(12) Patent Application Publication
(10) Pub. No.: US 2009/0116758 A1
(43) Pub. Date: May 7, 2009

(54) Device For Encoding Semantics Of Text-Based Documents

(76) Inventor: Alexander Stanislavovich Shmelev, Moscow (RU)

Correspondence Address: BIRCH STEWART KOLASCH & BIRCH, PO BOX 747, FALLS CHURCH, VA, 22040-0747, US

(21) Appl. No.: 11/988,020

(22) PCT Filed: Dec. 1, 2006
(86) PCT No.: PCT/RU2006/000007

§ 371 Date: Dec. 28, 2007

(51) Int. Cl. G06K 9/36

(52) U.S. Cl. 382/234

(57) ABSTRACT

The invention relates to data processing for dedicated applications, in particular for forming the semantic code vector of text-based document by transformation of initial digital codes into weighted codes The inventive device comprises N parallel adders, N weight number multipliers and N image compression units. Said device exhibits high functionality, thereby making it possible to form a semantic code vector of text-based document.

The invention relates to a data processing for dedicated applications, in particular for transformation of initial digital codes into weighted codes. The invention could be used for encoding semantics of text-based document when source semantic information defined by text document is transformed by special encoding algorithm into semantic code vector corresponding to that text-based document.

The device, which contains sawtooth generators, analog-digital and digital-analog converters, OR elements, memory units of membership function, units of minimum definition, comparators, units of subtraction from 1, registers, counter and delay units with corresponding links is disclosed in Inventor's certificate SU No. 1791815, cl. G06F 7/58, 1990.

The disadvantage of this device is relatively narrow functionability.

In the means of technical features, the closest device to claimed one is a device, which contains n parallel adders, inputs and outputs of which are corresponding to group of inputs and outputs of device, and n weight number multipliers wherein input of i weight number multiplier is connected with output of i parallel adder (i=1 . . . N) and each output of j weight number multiplier (j=1 . . . N) is connected with corresponding weighted signal input of i parallel adder (where i is not equal j) [A. B. Nazarov, A. I. Loskutov “Neuronet algorithms of the system forecasting and optimization”, St. Petersburg, “Science and Engineering”, 2003, picture 2.8,64].

The disadvantage of this device is relatively narrow functionality. The narrow functionalities are caused by the fact that the device forms only an output code on the basis of the source data, as a correspondence between source data and one of the previously set templates (patterns), but does not form a semantic code vector of text-based document by initial data of a document.

The claimed technical result is high functionality of device to form semantic code vector of a text-based document.

The claimed device comprising ii parallel adders, inputs of which are corresponding to group of device inputs and n weight number multipliers wherein each output of j weight number multiplier (j=1 . . . N) is connected with corresponding weighted signal input of i parallel adder (i=1 . . . N, where i is not equal j) also comprises n image compression units, which outputs are outputs device, wherein inputs of i weight number multiplier (i=1 . . . N) are connected with outputs of same image compression units, inputs of image compression units are connected with outputs of same parallel adders.

Moreover, the claimed technical result is obtained by the fact, that image compression units are designed as functional converters of input signal X into output signal Y by the following law: Y=1/(1+exp(−X)).

The description is accompanied by drawings:

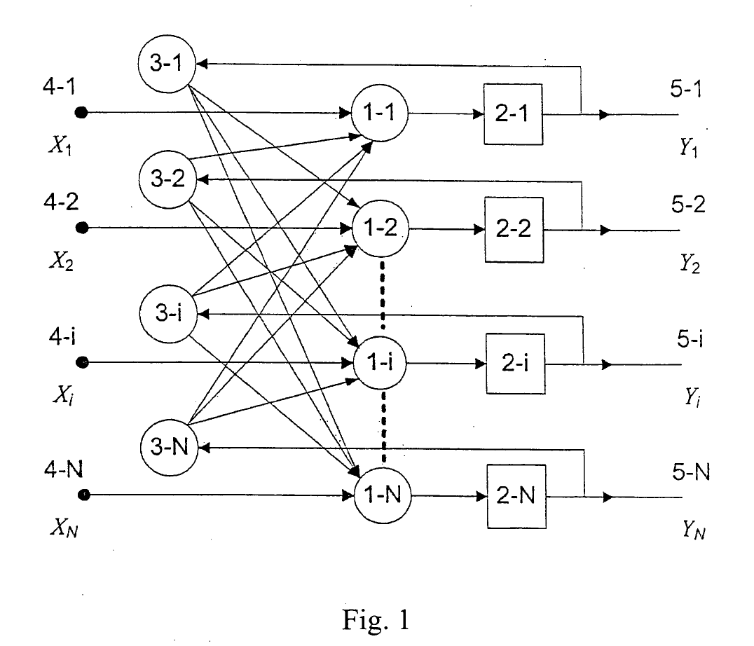

FIG. 1—block diagram of the device for encoding semantics of text-based document,

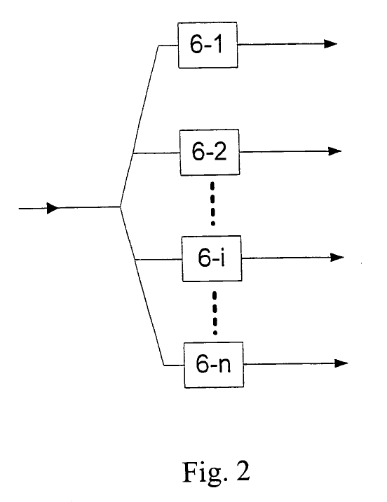

FIG. 2—block diagram of weight number multiplier.

The device for encoding semantics of text-based document (FIG. 1) consists of n parallel adders 1-1 . . . 1-N, n image compression units 2-1 . . . 2-N, and n weight number multipliers 3-1 . . . 3-N. At that inputs of 3-1 . . . 3-N weight number multipliers i (i=1 . . . N) are connected with outputs of 2-1 . . . 2-N image compression units of the same name, inputs of 2-1 . . . 2-N image compression units are connected with outputs of 1-1 . . . 1-N parallel adders of the same name, at that inputs of 1-1 . . . 1-N parallel adders mark input group 4-1 . . . 4-N of the device and outputs of 2-1 . . . 2-N image compression units mark output group 5-1 . . . 5-N of the device.

Moreover, each of the outputs of 3-1 . . . 3-N weight number multipliers j (j=1 . . . N) is connected to corresponding weighted signal input of 1-1 . . . 1-N parallel adder i (where i is not equal j), and 2-1 . . . 2-N image compression units designed as functional converters of input signal X into output signal Y by the following law: Y=1/(1+exp(−X)).

Weight number multipliers 3-1 . . . 3-N (FIG. 2) contain n weight coefficient multipliers 6-1 . . . 6-N with jointed input which mark corresponding input of weight number multipliers 3-1 . . . 3-N, and output of multipliers are an output of corresponding weight number multipliers 3-1 . . . 3-N.

Parallel adders 1-1 . . . 1-N and multipliers 6-1 . . . 6-N are standard elements of computers, and image compression units 2-1 . . . 2-N, which execute transfer functions of input signal X into output signal Y by the law Y=1/(1+exp(−X), could be designed as special computer devices. In particular, they could be designed as Programmable Read-Only Memory (PROM), where each of the initial input codes is corresponding with required output code. Presented functional dependence Y=1/(1+exp(−X)) is sufficient for technical (program) realization of image compression units.

The device for encoding semantics of text-based document works by the following algorithm.

In advance examine the technology of text encoding, realized in the device.

This realized technology of text encoding is based on a model of text corpus in a form of associative semantic network. The joints of this network are presented by terms or key words of text corpus. Each of this term is transformed to a normal form, and links between them represent their relations.

The weights of links are defined by text corpus analysis as relative probabilities of combined entry of terms, corresponding to examined joints.

Let us designate the quantity of all joints of associative semantic network as A={Aᵢ|i=1, . . . N}, the number of entries of term A in documents corpus as # A, and a orientated link with a beginning in Aᵢ and an end in Aⱼ as [symbol] Aᵢ, Aⱼ [symbol] .

We assume that the weights of links of associative semantic network answer the following requirements:

1) wᵢⱼ is a weight of a link between an output of node i and an input of node j;

2) ∀i, j=1, . . . , N, 0≦wᵢⱼ≦1, where N is a number of nodes;

$$∀ i = 1 , ... , N , {\sum }_{j = 1}^{N} {w}_{ij} \underline{<} 1. \qquad 3 )$$

There are different ways of analysis of combined entries of terms, when the links weights of semantic network are defined. The following two methods of weight calculation were used by us:

Method 1. Forming by sentences.

If the pair of terms {A,B} is an entry in one common sentence of some document of documents corpus, then nodes A and B would be connected with [symbol] A, B [symbol] and [symbol] B, A [symbol] links.

Let us designate the number of combined entries of terms A and B into sentences of documents corpus as #{A,B}. A weight value wᵢⱼ=#{Aᵢ,Aⱼ}/#Aᵢ we compare to the link [symbol] Aᵢ,Aⱼ [symbol] and a weight value wⱼᵢ=#{Aᵢ,Aⱼ}/#Aⱼ we compare to the reversed link [symbol] Aⱼ,Aᵢ [symbol] . Weight wᵢⱼ could be interpreted as a “relative weight” of combined entries of terms Aᵢ and Aⱼ in sentences of documents corpus in relation to all entries of term Aᵢ in documents corpus. It also could be interpreted as a relative probability P({Aᵢ,Aⱼ}|Aᵢ). If terms Aᵢ and Aⱼ don't have any combined entries in sentences of documents corpus, then wᵢⱼ=wⱼᵢ=0.

Method 2. Forming by window.

We will consider some close neighbourhood (window) for each term in collection document we are going to examine its close surroundings (window). In particular let's consider window [(wₙ₋₂wₙ₋₁)fₙ(wₙ₊₁wₙ)], where fₙ—central element of the window. For example for piece of the text “this parrot is no more” such window would be represented as

[(this parrot) is (no more)]. If the pair of terms {A,B} is an entry in one common window of documents corpus, then nodes A and B would be connected with [symbol] A,B [symbol] and [symbol] B,A [symbol] links.

Let #{A,B} is a number of all entries of term B into all windows with central element A. A weight value wᵢⱼ=#{Aᵢ,Aⱼ}/#Aᵢ we compare to the link [symbol] Aᵢ,Aⱼ [symbol] . A weight value wⱼᵢ=#{Aᵢ,Aⱼ}/#Aⱼ we compare to the reversed link [symbol] Aⱼ,Aᵢ [symbol] .

In the means of semantic, associative semantic network generates sense context of documents corpus. According to it semantic code vectors of text documents are generated. We are using that associative semantic network for creating single-layered neural network with feedback and parallel dynamics. The last neural network generates a semantic code vectors. It is created by the following construction.

Let us identify the node Aᵢ of associative semantic network with the node i of our neural network. Then let us put an output value of node i with weight coefficient wᵢⱼ in input of node j. As a network node activation function, we are going to choose sigmoid function

$$h ( x ) = \frac{1}{1 + {e}^{- x}} ,$$

which is a contracted mapping.

For document D semantic code vector generation, we set the initial N-dimensional code vector X_{D} which consists of 0 and 1. N is a number of nodes of associative semantic network. The i-th component of the vector X_{D} is 1, if term Aᵢ is entered in document D, otherwise the i-th component of the vector X_{D} is 0.

Let us set the vector X_{D} as an input of the our neural network. The sequence of iterations reaches the unique equilibrium point, which is dependent of initial vector X_{D} only and therefore found equilibrium point is dependent of document D only. We set this found equilibrium point as a semantic code vector of a document D.

Described above technology realized as following way in the presented device previously.

The initial N-dimensional code vector X_{D} sets as an input of parallel adders 1-1 . . . 1-N, which are an 4-1 . . . 4-N input group of the device. In particular this vector, which is initial data of corresponding text document, consists of signals with levels of logical 0 and 1. Signals from an output of parallel adders 1-1 . . . 1-N are set as an input of corresponding image compression units 2-1 . . . 2-N, where functional transformation executes by the law Y=1/(1+exp(−X)). Signals, transformed in such way, are set as an input of corresponding weight number multipliers 3-1 . . . 3-N, where multiplication of output of image compression units 2-1 . . . 2-N on weight coefficients wᵢⱼ executes. As far as each output of j (j=1 . . . N) weight number multipliers 3-1 . . . 3-N connected with corresponding input of weighted signal of i (i=1 . . . N) parallel adder 1-1 . . . 1-N, it provides setting of an output of multipliers 3-1 . . . 3-N on an input of corresponding parallel adders 1-1 . . . 1-N. After the end of a short transitional process on output group 5-1 . . . 5-N of the device, semantic code vector of a corresponding text document is formed.

Said device exhibits high functionality, thereby making it possible to form a semantic code vector of text-based document.

1. The device for encoding of semantics of text-based document comprising n parallel adders, inputs of which are corresponding to group of device inputs and ii weight number multipliers, wherein each output of j weight number multiplier (j=1 . . . N) is connected with corresponding weighted signal input of i parallel adder (i=1 . . . N, where i is not equal j) characterized in that the device comprises n image compression units, which outputs are outputs device, wherein inputs of i weight number multiplier (i=1 . . . N) are connected with outputs of same image compression units, inputs of image compression units are connected with outputs of same parallel adders.

2. The device for encoding semantics of text-based document of claim 1, characterized in that the image compression units designed as functional converters of input signal X into output signal Y by the following law: Y=1/(1+exp(−X)).
